(19) United States
(12) Patent Application Publication
(10) Pub. No.: US 2023/0331332 A1
(43) Pub. Date: Oct. 19, 2023

(54) FUEL TANK ARRANGEMENT AND VEHICLE

(71) Applicant: KTM AG, Mattighofen (AT)

(72) Inventor: Alexander REINDL, Uttendorf (AT)

(21) Appl. No.: 18/133,108

(22) Filed: Apr. 11, 2023

(30) Foreign Application Priority Data
Apr. 13, 2022 (AT) A 50242/2022

(51) Int. Cl. B62J 35/00; B62K 11/04

(52) U.S. Cl. CPC B62J 35/00; B62K 11/04

(57) ABSTRACT

A fuel tank arrangement for a vehicle, in particular a motorcycle, includes a first tank body, a second tank body, and a connecting element, via which there is a fluid connection and, optionally, a mechanical connection between the first tank body and the second tank body. The first tank body is spaced apart from the second tank body in such a way that there is a free space between the first tank body and the second tank body and, where applicable, the connecting element, in which at least one further structural component of the vehicle can be arranged.

### BACKGROUND OF THE INVENTION

The present invention relates to a fuel tank arrangement for a vehicle, in particular a motorcycle.

Generic fuel tank arrangements have a first tank body, at least one second tank body and at least one connecting element, via which there is a fluid connection and, optionally, a mechanical connection between the first tank body and the at least one second tank body.

In the case of motorcycles, fuel tanks having a plurality of tank bodies are known in principle. Reference is to be made, for example, to EP 3738813 A1.

Fuel tanks having a plurality of tank bodies offer advantages in terms of both the flexibility of the tank arrangement on the vehicle and ease of production of the fuel tank arrangement.

The flexibility of the arrangement, in particular, is particularly advantageous precisely in the case of motorcycles, but also in the case of other vehicles, as the installation space available on the vehicle is very limited. Thus, in the development of vehicles considerable effort is put into utilizing the available installation space as effectively as possible (so-called “packaging”).

### SUMMARY OF THE INVENTION 2

The object of the present invention is to improve fuel tank arrangements according to the state of the art in terms of the effective utilization of the installation space.

This object is achieved by the first tank body being spaced apart from the at least one second tank body in such a way that there is a free space between the first tank body and the at least one second tank body and, where applicable, the at least one connecting element, in which at least one further structural component of the vehicle can be arranged.

There may, of course, be more than one free space in this way.

In itself it is counterintuitive to space the at least one second tank body so far apart from the first tank body that a substantial free space results. However, a fundamental aspect of the invention is to consciously introduce this spacing in such a way that certain structural components of the vehicle, such as for example a device for separating fuel vapours, can be accommodated in the free space created according to the invention, preferably substantially with a perfect fit.

The at least one further structural component can preferably include at least one of the following:
a device for separating fuel vapours, for example in the form of a so-called activated carbon filter module (ACF module for short),
a control unit, for example for implementing engine and/or brake functions (for example an ABS module),
a pump, for example for fuel, in particular an external fuel pump, and/or
a compensating fluid reservoir, for example for coolant.

Moreover, protection is sought for an arrangement of a fuel tank arrangement and at least one further structural component arranged in the free space.

Furthermore, protection is sought for a vehicle, in particular a motorcycle, which has a fuel tank arrangement according to the invention and/or an arrangement according to the invention.

The vehicle may be, in particular, a single-track vehicle. However, multi-track vehicles may of course also be equipped, in principle, with a fuel tank arrangement according to the invention.

Examples of further vehicles include all-terrain vehicles (ATVs) or quad bikes.

It should be noted that the first tank body and the at least one second tank body can, in principle, be in contact with one another, for example via the at least one connecting element, if this is designed integrally with the first tank body and/or the at least one second tank body.

However, the spacing according to the invention for creating a free space is only present if the distance between the first tank body and the at least one second tank body is sufficiently great, at least in regions, that the resulting free space can be used in a technically meaningful way for the arrangement of further structural components—i.e. structural components separate from the first tank body, from the at least one second tank body and from the at least one connecting element—of the vehicle.

In the region of the free space, the minimum clearance in some regions may be, for example, at least 1 cm, preferably 3 cm, and particularly preferably 5 cm for that reason.

In particularly preferred embodiments, the minimum clearance in the region of the free space is approximately 7 cm.

In principle, the at least one connecting element can be arranged between the first tank body and the at least one second tank body and/or outside an intermediate space between the first tank body and the at least one second tank body. If the at least one connecting element is between the first tank body and the at least one second tank body, the free space according to the invention will in most cases also be delimited by the at least one connecting element.

The first tank body can preferably include a first tank volume and/or the at least one second tank body can preferably include at least one second tank volume.

According to the invention, the at least one connecting element produces a fluid connection between the first tank body and the at least one second tank body, such that fuel can pass from the first tank volume into the at least one second tank volume.

The at least one connecting element optionally provides a mechanical connection between the first tank body and the at least one second tank body, as a result of which the first tank body and the at least one second tank body are structurally attached to one another and preferably form an assembly to be mounted together, for example on a frame of the vehicle.

The fuel to be held in the tank can preferably be petrol or a mixture. Other fuels, such as for example diesel or hydrogen, are of course also conceivable in principle.

The at least one second tank body can be arranged below the first tank body in the state in which the fuel tank arrangement is mounted on the vehicle.

The free space may be between a first outer surface of the first tank body and at least one second outer surface of the at least one second tank body, wherein
the first outer surface and the at least one second outer surface are substantially parallel to one another and/or
the first outer surface is substantially horizontal in the state in which the fuel tank arrangement is mounted on the vehicle and/or
the at least one second outer surface is substantially horizontal in the state in which the fuel tank arrangement is mounted on the vehicle.

Embodiments in which the outer surfaces are at an angle with respect to one another and/or with respect to the horizontal are of course also conceivable.

The geometric shape of the free space may of course preferably be determined by the at least one further structural component.

Preferably, precisely one first tank body can be present.

Preferably, precisely two second tank bodies can be present.

The first tank body can preferably be arranged centrally in the lateral direction in the state in which the fuel tank arrangement is mounted on the vehicle. In other words, the first tank body can have its centre of mass on a central longitudinal vehicle axis when the fuel tank arrangement is mounted on the vehicle.

In preferred embodiment, the first tank body can be formed substantially mirror-symmetrical with respect to the central longitudinal vehicle axis.

The at least one second tank body can be arranged laterally in the state in which the fuel tank arrangement is mounted on the vehicle, wherein preferably one second tank body is arranged on the left and one second tank body is arranged on the right.

In this regard, it may be particularly preferred for one second tank body to be located on the left and another second tank body to be located on the right of a drive motor of the vehicle when the fuel tank arrangement is mounted on the vehicle.

The fuel tank arrangement can have at least one mounting element by means of which the fuel tank arrangement can be attached to a chassis and/or a frame of the vehicle.

The first tank body and/or the at least one second tank body can preferably be produced by injection moulding and/or blow moulding and/or as a welded sheet metal tank.

In the case of a welded sheet metal tank, aluminium sheet and/or steel sheet can be used, for example.

As already mentioned, the at least one connecting element can be designed integrally with the first tank body and/or the at least one second tank body or separately from the first tank body and/or from the at least one second tank body.

The at least one connecting element for mechanically connecting and/or for producing the fluid connection between the first tank body and the at least one second tank body can preferably be co-produced in a production process of the first tank body and/or the second tank body.

In the case of a welded sheet metal tank, the at least one connecting element could be welded on and/or joined separately, for example as an insert element.

In other words, the at least one connecting element can be produced at the same time as the production of the first tank body and/or the at least one second tank body.

Designing the at least one connecting element integrally with the first tank body and/or the at least one second tank body can be realized particularly easily in this way.

A dimension of the at least one further structural component can preferably substantially correspond to a distance between the first tank body and the at least one second tank body. In other words, the at least one further structural component can be arranged in the free space between the first tank body and the at least one second tank body with a perfect fit.

The dimension of the at least one further structural component substantially corresponding to the distance between the first tank body and the at least one second tank body can be understood to mean that there is no longer any distance to speak of between the first tank body and the further structural component and/or between the further structural component and the at least one further tank body; preferably only clearances and manufacturing tolerances account for any remaining intermediate spaces.

In particularly preferred embodiments of the invention, the at least one further structural component can be mounted on the fuel tank arrangement, can preferably be mounted exclusively on the fuel tank arrangement—and not on other components of the vehicle, for instance.

Such a pre-assembly of the at least one further structural component can be particularly advantageous for the production of the vehicle because then the fuel tank arrangement can be mounted together with the at least one further structural component.

Cables or hoses, for example, which connect the at least one further structural component to the fuel tank arrangement, can then be arranged particularly simply in such a way that they do not kink or rub. This advantage arises particularly in the case of a device for separating fuel vapours from the tank.

The vehicle can preferably have a saddle for a rider, wherein the fuel tank arrangement is arranged in front of and/or behind the saddle in the direction of travel.

The mentioned device for separating fuel vapours can preferably be connected to an interior space of the fuel tank arrangement in the region of a tank cap of the fuel tank arrangement, such that the fuel vapours can be fed to the device and at the same time the risk that liquid fuel reaches the device is minimized.

The fuel separated in the device can be fed back into the fuel tank arrangement, for example, or can be fed to a drive motor of the vehicle.

As mentioned, the device for separating fuel vapours can be formed as an active carbon filter module (ACF module).

The drive motor of the vehicle can be, in particular, an internal combustion engine.

### BRIEF DESCRIPTION OF THE DRAWINGS

Further advantages and details of the invention emerge from the figures and the associated description of the figures, in which:

FIG. 6

FIG. 1 shows an embodiment of a fuel tank arrangement according to the invention,

FIG. 2 is a side view of the embodiment from FIG. 1,

FIG. 3 shows a further embodiment of a fuel tank arrangement according to the invention,

FIG. 4 is an analogous representation to FIG. 2 in the state in which the embodiment is mounted on a frame part,

FIG. 5 is an analogous representation to FIG. 4, wherein an engine compartment is indicated,

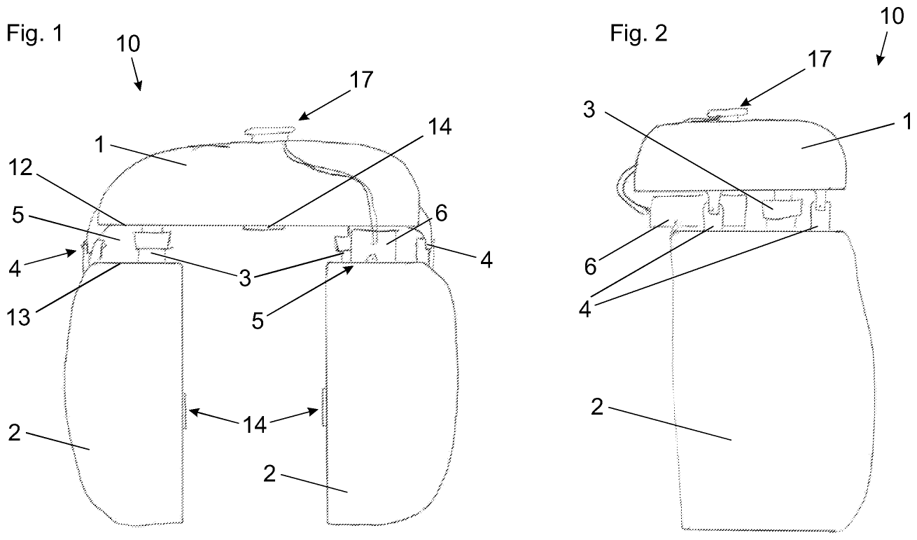

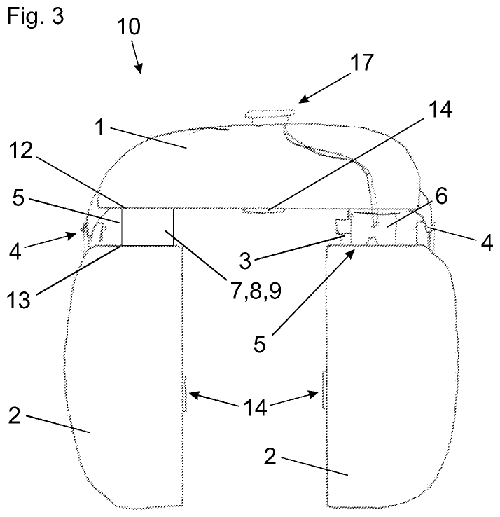

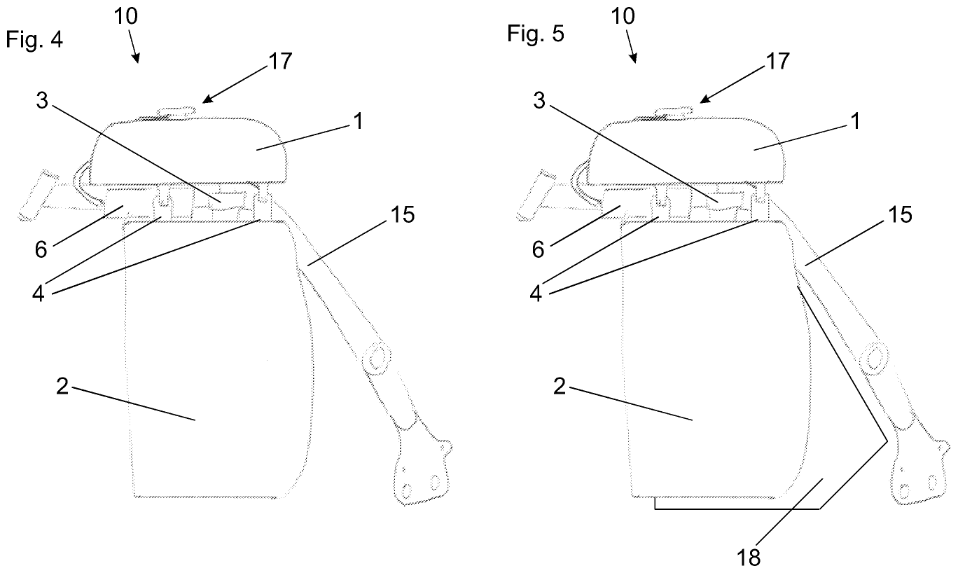

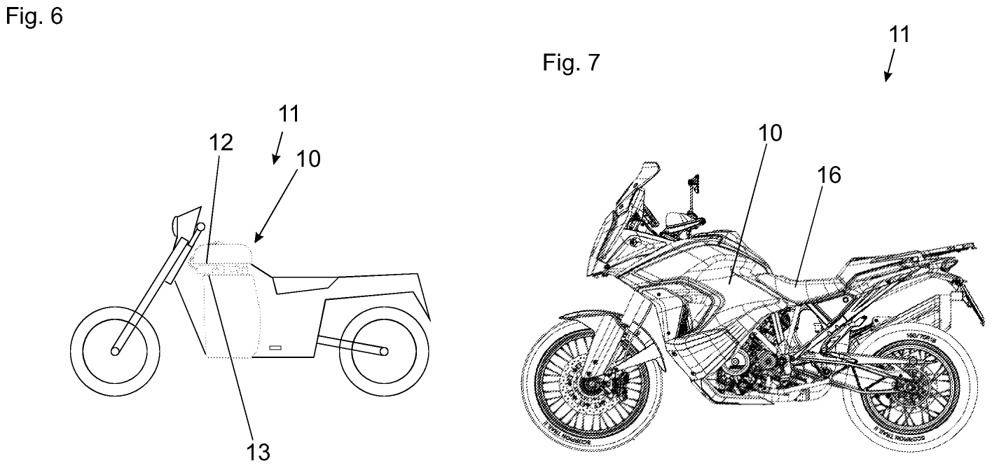

FIG. 6 is a representation of an embodiment of a vehicle having a fuel tank arrangement according to the invention, and

FIG. 7 shows an embodiment of a vehicle according to the invention.

### DETAILED DESCRIPTION OF THE INVENTION

FIG. 1 shows an embodiment of a fuel tank arrangement 10 according to the invention, having a first tank body 1 and two second tank bodies 2.

Connecting elements 3 that provide a fluid connection between the first tank body 1 and the second tank bodies 2 are provided.

Fuel, for example petrol, which can be added to the first tank body 1 via the tank cap 17, can also pass into the second tank bodies 2 via the mentioned fluid connection.

Moreover, connecting elements 3 that produce a mechanical connection between the first tank body 1 and the second tank bodies 2 are provided.

The embodiment shown in FIG. 1 is thereby realized as a combined assembly, which is not absolutely necessary for the invention, however.

It should be mentioned that the connecting elements 3 that provide the fluid connection could well also have a mechanical connection function. In the present embodiment, however, they have no mechanical connection function, or only a very minor one.

According to the invention there is a free space 5 between the first tank body 1, each of the second tank bodies 2 and the connecting elements 3, 4, which can be utilized for further structural components.

In this embodiment, a device 6 for separating fuel vapours is provided between the first tank body 1 and the second tank body 2 on the right in the drawing.

The device 6 is formed as an ACF module in this embodiment.

In this embodiment, the device 6 is connected to an interior space of the fuel tank arrangement 10 in the region of the tank cap 17, for example to the interior space (first volume) of the first tank body 1 in the present embodiment.

As can be seen from the free space 5 between the first tank body 1 and the second tank body 2 represented on the left in FIG. 1, this free space 5 remains empty in this embodiment.

It can be seen that the free space 5 is respectively delimited by a first outer surface 12 of the first tank body 1 and a second outer surface 13 of the second tank body 2.

In this embodiment, the first outer surface 12 and the second outer surface 13 are parallel to one another, which creates an advantageous, substantially cuboid, free space 5, which is well suited for use by further structural components of the vehicle 11.

In particularly preferred embodiments, the free space is adapted to the geometry of the at least one further structural component; i.e. the first tank body 1 and the at least one second tank body 2 then make, preferably substantially only, the outline of the at least one further structural component available.

According to FIG. 1, the fuel tank arrangement 10 can, for example, be mounted on a frame 15 of a vehicle 11 by means of the mounting elements 14 (see in this regard FIGS. 5 to 7, for example).

FIG. 2 shows the embodiment from FIG. 1 in a side view.

FIG. 3 shows an embodiment analogous to the embodiment from FIG. 1, wherein at least one further structural component, namely a control unit 7 and/or a pump 8 and/or a compensating fluid reservoir 9, is arranged in the free space 5 between the first tank body 1 and the second tank body 2 represented on the left.

FIG. 4 is analogous to FIG. 2, wherein the embodiment is represented in a state in which it is mounted on a frame component of the frame 15 of the vehicle 11, namely by means of the aforementioned mounting elements 14.

In this exemplary embodiment, the frame component is formed to hold a drive motor and to receive a front wheel fork.

FIG. 5 is analogous to FIG. 4, wherein an engine compartment 18 has also been schematically indicated. The drive motor can be accommodated in this engine compartment 18, at least in part between the two second tank bodies 2.

FIG. 6 shows, purely schematically, an embodiment according to the invention of a vehicle 11 having a fuel tank arrangement according to the invention.

It can be seen, among other things, in FIG. 6 that the first outer surface 12 and the second outer surface 13 are substantially horizontal in the state in which the fuel tank device 10 according to the invention is mounted on the vehicle 11.

As already mentioned, the first outer surface 12 and/or the second outer surface 13 can also form angles with respect to one another and/or with respect to the horizontal, wherein this can have an influence on the distribution of the fuel in the first tank body 1 and in the at least one second tank body 2.

The free space 5 resulting from the spacing of the first tank body 1 from the visible second tank body 2 can be clearly seen in the representation from FIG. 3. In particular, it can be seen that the free space 5 is substantially cuboid owing to the horizontal and parallel design of the first outer surface 12 and the second outer surface 13, which is why the free space is particularly well suited for use—even if it has been left blank here for the sake of better clarity.

FIG. 7 shows an alternative embodiment of a vehicle 11 according to the invention—a motorcycle here too.

The fuel tank arrangement 10 according to the invention is covered here by a motorcycle fairing to protect the fuel tank arrangement 10. The position of the fuel tank arrangement 10 is indicated by the reference number, however.

It can therefore be seen that the fuel tank arrangement 10 is arranged in front of the saddle 16 of the vehicle 11 in the direction of travel.

It should be mentioned that the saddle 16 can be mounted on a frame component analogously to that from FIGS. 4 and 5.

It should be mentioned that the connecting elements 3, 4 do not have to be in or at an intermediate space between the first tank body 1 and the second tank body 2, as in the present embodiments. They can also be further away, for example, such that the free space 5 according to the invention is only delimited by the first tank body 1 and by the at least one second tank body 2, for example.

Connecting elements 4, which produce a mechanical connection between the first tank body 1 and the at least one second tank body 2, are not a necessity within the scope of the invention.

For example, the first tank body 1 and the at least one second tank body 2 could also be attached to a frame 15 of the vehicle 11 separately from one another.

### LIST OF REFERENCE NUMBERS

1 first tank body
2 at least one second tank body
3 connecting element (fluid connection)
4 connecting element (mechanical connection)
free space
6 device for separating fuel vapours
7 control unit
8 pump
9 compensating fluid reservoir
10 fuel tank arrangement
11 vehicle
12 first outer surface
13 second outer surface
14 at least one mounting element
frame
16 saddle
17 tank cap
18 engine compartment

1. A fuel tank arrangement for a vehicle, in particular a motorcycle, having a first tank body, at least one second tank body and at least one connecting element, via which there is a fluid connection and, optionally, a mechanical connection between the first tank body and the at least one second tank body, wherein the first tank body is spaced apart from the at least one second tank body in such a way that there is a free space between the first tank body and the at least one second tank body and, where applicable, the at least one connecting element, in which at least one further structural component of the vehicle can be arranged.

2. The fuel tank arrangement according to claim 1, wherein the at least one further structural component includes at least one of the following: a device for separating fuel vapors, a control unit, a pump and/or a compensating fluid reservoir.

3. The fuel tank arrangement according to claim 1, wherein the at least one second tank body is arranged below the first tank body in the state in which the fuel tank arrangement is mounted on the vehicle.

4. The fuel tank arrangement according to claim 1, wherein the free space is between a first outer surface of the first tank body and at least one second outer surface of the at least one second tank body, wherein preferably
the first outer surface and the at least one second outer surface are substantially parallel to one another and/or
the first outer surface is substantially horizontal in the state in which the fuel tank arrangement is mounted on the vehicle and/or
the at least one second outer surface is substantially horizontal in the state in which the fuel tank arrangement is mounted on the vehicle.

5. The fuel tank arrangement according to claim 1, wherein precisely one first tank body is present and/or that precisely two second tank bodies are present.

6. The fuel tank arrangement according to claim 1, wherein the first tank body is arranged centrally in the lateral direction in the state in which the fuel tank arrangement is mounted on the vehicle and/or in that the at least one second tank body is arranged laterally in the state in which the fuel tank arrangement is mounted on the vehicle, wherein preferably one second tank body is arranged on the left and one second tank body is arranged on the right.

7. The fuel tank arrangement according to claim 1, wherein the fuel tank arrangement has at least one mounting element by means of which the fuel tank arrangement can be attached to a chassis and/or a frame of the vehicle.

8. The fuel tank arrangement according to claim 1, wherein the first tank body and/or the at least one second tank body is produced by injection moulding and/or blow moulding and/or as a welded sheet metal tank.

9. The fuel tank arrangement according to claim 8, wherein the at least one connecting element for mechanically connecting and/or for producing the fluid connection between the first tank body (1) and the at least one second tank body is co-produced in a production process of the first tank body and/or the second tank body.

10. An arrangement of a fuel tank arrangement according to claim 1 and at least one further structural component arranged in the free space, in particular a device for separating fuel vapours, a control unit, a pump and/or a compensating fluid reservoir.

11. The arrangement according to claim 10, wherein a dimension of the at least one further structural component substantially corresponds to a distance between the first tank body and the at least one second tank body.

12. The arrangement according to claim 10, wherein the at least one further structural component is mounted on the fuel tank arrangement, preferably is mounted exclusively on the fuel tank arrangement.

13. A vehicle, in particular a motorcycle, having the arrangement according to claim 10.

14. The vehicle according to claim 13, wherein the vehicle has a saddle for a rider, wherein the fuel tank arrangement is arranged in front of and/or behind the saddle in the direction of travel.
